(19) United States
(12) Patent Application Publication
(10) Pub. No.: US 2009/0168905 A1
(43) Pub. Date: Jul. 2, 2009

(54) Decoding of LVDS Protocols

(75) Inventors: Donald Eric Thompson, Thousand Oaks, CA (US); David Wayne Stonely, Fukuoka (JP)

Correspondence Address: TERADYNE, INC.;c/o FOLEY & LARDER, LLP, 111 HUNTINGTON AVENUE, 26TH FLOOR, BOSTON, MA, 02199-7610, US

(73) Assignee: Teradyne, Inc.

(21) Appl. No.: 12/048,069

(22) Filed: Mar. 13, 2008

Related U.S. Application Data
(60) Provisional application No. 61/017,521, filed on Dec. 28, 2007.

(51) Int. Cl. H04B 3/00

(52) U.S. Cl. 375/257

(57) ABSTRACT

An embodiment of the invention is directed to a system for processing a plurality of encoded signals carrying data. The system includes an electronic circuit configured to receive the encoded signals from one or more external devices, wherein the data are encoded in the encoded signals according to one or more of a plurality of protocols. The system further includes a processor configured to receive the encoded signals from the electronic circuit, and to extract the data from the encoded signals by decoding the encoded signals. The processor is configured to perform decoding according to the plurality of protocols.

### CROSS-REFERENCE TO RELATED PATENT APPLICATIONS

This application claims priority from U.S. Provisional Application No. 61/017,521, filed on Dec. 28, 2007, incorporated herein by reference in its entirety.

### FIELD OF THE INVENTION

The present invention relates generally to decoding of low-voltage differential signaling (LVDS) protocols.

### BACKGROUND

Automatic test equipment (ATE) refers to an automated, usually computer-driven, system for testing devices, such as semiconductors, electronic circuits, and printed circuit board assemblies. A device tested by ATE is referred to as a device under test (DUT).

ATE typically includes a computer system and a testing device or a single device having corresponding functionality. ATE may receive data from the DUT via a data bus. The data may be transferred via the data bus via low voltage differential signaling (LVDS). Although LVDS is generally a multipurpose interface standard, specific applications using LVDS may encode data, which are to be transferred, based on any of various standard protocols (e.g., to increase fidelity of the data). Examples of such protocols include the Standard Mobile Imaging Architecture (SMIA) and the Mobile Industry Processor Interface (MIPI). As such, data arriving at ATE from the DUT may be in an encoded form.

### SUMMARY OF THE DISCLOSURE

Various embodiments of the present invention are directed to providing a system for processing data encoded according to any one of multiple protocols and/or variations thereof (including, but not limited to, “one-off” protocols, which are based on standard protocols). In particular, certain embodiments are directed to decoding low voltage differential signaling (LVDS) data carrying image data provided by image sensor devices.

Although certain embodiments are described herein with reference to ATE, other embodiments may be used for processing data for purposes other than testing. In addition, although certain embodiments are described herein with reference to LVDS data, other embodiments may be used for processing data transmitted according to other signaling systems (including, but not limited to, other types of differential signaling).

An embodiment of the invention is directed to a system for processing a plurality of encoded signals carrying data. The system includes an electronic circuit configured to receive the encoded signals from one or more external devices, wherein the data are encoded in the encoded signals according to one or more of a plurality of protocols. The system further includes a processor configured to receive the encoded signals from the electronic circuit, and to extract the data from the encoded signals by decoding the encoded signals. The processor is configured to perform decoding according to the plurality of protocols.

Another embodiment of the invention is directed to a method for processing a plurality of encoded signals carrying data. The method includes: receiving the encoded signals from one or more external devices, wherein the data are encoded in the encoded signals according to one or more of a plurality of protocols; sending the encoded signals to a processor for performing decoding according to the plurality of protocols; and extracting the data from the encoded signals by decoding the encoded signals.

### BRIEF DESCRIPTION OF THE DRAWINGS

FIG. 1 is a block diagram of automatic test equipment (ATE) for testing devices.

FIG. 2 is a block diagram of a processing system according to an embodiment of the present invention.

FIG. 3 is a flowchart of a method for processing decoded data, according to an embodiment of the present invention.

Like reference numerals in different figures indicate like elements.

### DETAILED DESCRIPTION OF THE PREFERRED EMBODIMENTS

Automatic test equipment (ATE) may be called upon to test devices that produce data that are encoded based on any one of a variety of low voltage differential signaling (LVDS) protocols. Testing the devices may involve analyzing the data produced by the devices. However, because each of the LVDS protocols may be different from one another, each of these protocols may require a different form of processing (including, but not limited to, decoding) at the receiving end. As such, ATE may need to process encoded data in a certain manner, according to the protocol that was used by the originating device in encoding the data.

Although certain embodiments are described herein with reference to ATE, other embodiments may be used for processing data for purposes other than testing. In addition, although certain embodiments are described herein with reference to LVDS data, other embodiments may be used for processing data transmitted according to other signaling systems (including, but not limited to, other types of differential signaling).

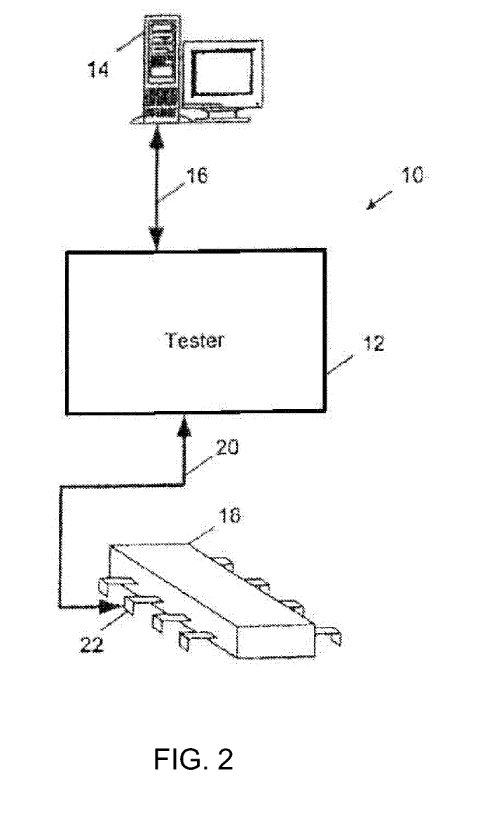

In embodiments of the present invention, a system for processing data includes a device under test (DUT) coupled to ATE. The DUT generates data that are received at and analyzed by the ATE for (including, but not limited to) determination of device characteristics). The data are transferred using an LVDS protocol via a data bus. That is, the data are protocol-encoded LVDS data. The ATE includes a capturing device for capturing the encoded LVDS data. The ATE also includes a processor for decoding the data and extracting the decoded data (including, but not limited to, raw data) from the encoded data stream. In certain embodiments that are directed to image data produced by an image sensor, the decoded data may include image data frames (see, e.g., image data frames 160 of FIG. 2). Such image frames may be analyzed to check for dead pixels, pixel sensitivity, and other pixel behavioral characteristics.

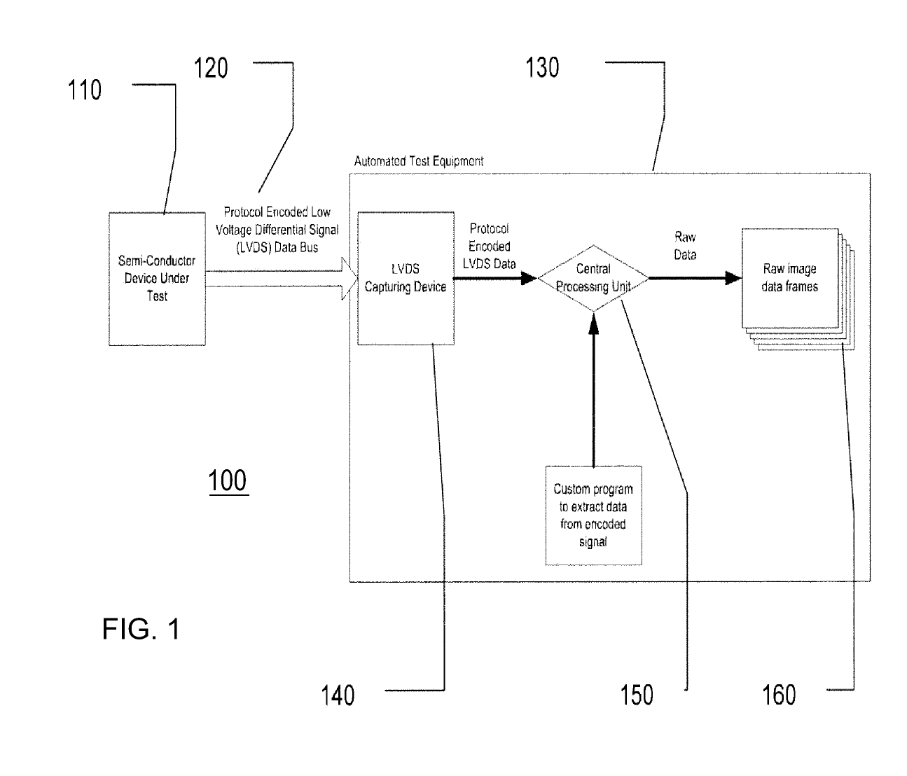

With reference to FIG. 1, a system 10 for testing a DUT 18 (including, but not limited to, a semiconductor device, an electronic circuit, a circuit board assembly, and the like) is shown. Examples of semiconductor devices to be tested by the system 10 include: an integrated circuit (IC) chip, a memory chip, a microprocessor, an analog-to-digital converter, a digital-to-analog converter, an image sensor device, and the like.

The system 10 includes a tester 12 (including, but not limited to, ATE or a similar testing device) and a computer system 14 for controlling the tester 12. The computer system 14 interfaces with the tester 12 over a connection 16 (including, but not limited to, a hardwire connection). In one embodiment, the computer system 14 sends commands to the tester 12 in order to initiate an execution of routines and functions for testing the DUT 18. Such executing test routines may, as described in further detail below, initiate the generation and transmission of test signals to the DUT 18 and the collection of responses from the DUT 18.

With continued reference to FIG. 1, to provide test signals and collect responses from the DUT 18, the tester 12 is connected to one or more connector pins (e.g., connector pin 22) of the DUT 18. These connector pins provide an external interface coupled to internal circuitry of the DUT 18. In some instances, 128 (or more) connector pins may be connected to the tester 12. As shown for illustrative purposes in the embodiment of FIG. 1, the tester 12 is connected to connector pin 22 of the DUT 18 via a hardwire connection. As shown in FIG. 1, a conductor 20 is used to connect the tester 12 and the connector pin 22. Test signals (including, but not limited to, precision measurement unit (PMU) test signals) are delivered from the tester 12 to the internal circuitry of the DUT 18 via the conductor 20.

The conductor 20 also senses signals at the pin 22 provided in response to the test signals delivered from the tester 12. For example, the DUT 18 may provide a voltage (or current) signal in response to a test signal delivered via the conductor 20. The voltage signal may be sensed at the pin 22 and delivered over the conductor 20 to the tester 12 for analysis.

FIG. 2 shows a block diagram of a processing system 100 according to an embodiment of the present invention.

With reference to FIG. 2, the system 100 includes a DUT 110. The DUT 110 produces data using LVDS. The data may be encoded according to a certain LVDS protocol. (As described earlier, examples of LVDS protocols include the Standard Mobile Imaging Architecture (SMIA) and the Mobile Industry Processor Interface (MIPI). However, embodiments of the invention are not limited thereto.) In one embodiment, the DUT 110 includes an image sensor device that produces image data.

The system 100 also includes ATE 130 coupled with external devices including, but not limited to, the DUT 110 via a data bus 120. The ATE 130 includes a capturing device 140. The capturing device 140 captures LVDS data provided to it. Those skilled in the art will appreciate that the capturing device 140 may capture the data using any suitable device or devices for capturing the data (including, but not limited to, memory or storage devices such as registers, disk drives, RAM devices, and the like).

The ATE 130 further includes a central processing unit 150 (such as, but not limited to, a microprocessor in a personal computer or more than one such microprocessors). The central processing unit 150 includes one or more software modules (and/or firmware modules) configured to decode data of (for example, extract raw data from) an encoded LVDS data stream. In one embodiment, the one or more software modules are configured to decode data according to any of a plurality of protocols.

In one embodiment, the central processing unit is configured to detect (or determine) the protocol by which a data stream is encoded. Here, each of the software modules may be configured to decode data that are encoded using a corresponding protocol (or variation thereof and/or modification thereto).

In another embodiment, the central processing unit 150 receives information that identifies the protocol by which the data stream is encoded. Accordingly, the central processing unit 150 decodes the data stream using the received information.

The central processing unit 150 may be supplied with the information in any one of various ways, before (or concurrent with) the receiving of data from the DUT 110. For example, a user may supply the ATE 130 with the information by interacting via a software program (or routine). The software program may be implemented at the central processing unit 150 or another processing unit of the ATE 130. As another example, the central processing unit 150 may be supplied with the information by loading a software program that informs the central processing unit 150 of the identify of the protocol. Here, the loading of the software program may be similar to installing a driver for a hardware device.

As such, the central processing unit 150 can accommodate any one of multiple protocols. For example, software modules (or variations thereof or modifications thereto) may be implemented in the central processing unit 150 to process different protocols (or variations thereof and/or modifications thereto).

In one embodiment, the capturing device 140 is located on a so-called “instrument board” of the ATE 130. In a further embodiment, the central processing unit 150 is located separate from the instrument board of the ATE 130.

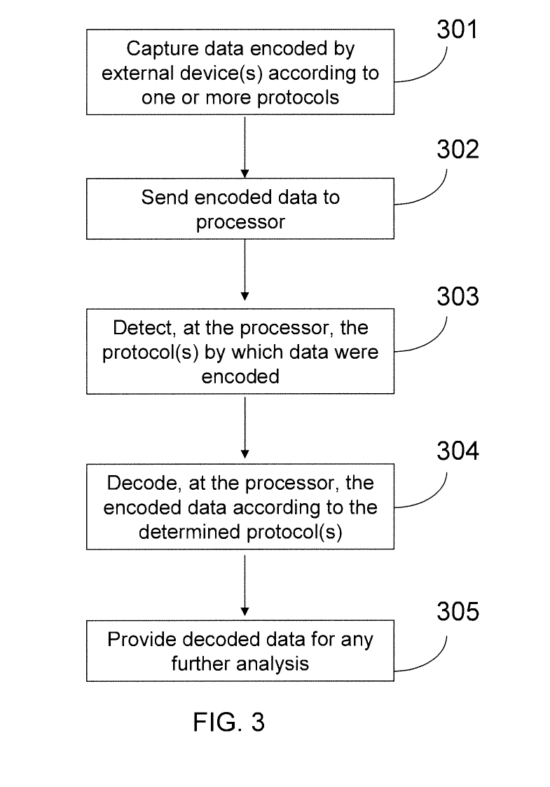

A method of processing decoded data will now be described in more detail with reference to FIGS. 2 and 3. The DUT 110 generates encoded LVDS data and provides the encoded data to the ATE 130 via the data bus 120. The LVDS capturing device 140 receives the encoded data from the DUT 110 via the data bus 120.

According to one embodiment, the processing of the encoded data, as performed by the capturing device 140, is generally relatively simple. That is, the capturing device 140 captures the encoded data provided to it by one or more external devices, such as the DUT 110 (see, for example, step 301 of FIG. 3). The capturing device 140 then provides the encoded data to the central processing unit 150 (see, for example, step 302 of FIG. 3). As such, the data received by the central processing unit 150 (from the DUT 110) remain in encoded form.

The central processing unit 150 decodes the encoded data using one or more software modules. In one embodiment, the central processing unit 150 detects the protocol(s) by which the encoded data were encoded (see, for example, step 303 of FIG. 3).

In another embodiment, the central processing unit 150 receives information that identifies the protocol by which the data stream is encoded (see, for example, step 303 of FIG. 3). Accordingly, the central processing unit 150 decodes the data stream using the supplied information. As previously described, the central processing 150 may be supplied with the information in any one of various ways, before (or concurrent with) the receiving of the data from the DUT 110.

Accordingly, a corresponding one (or more) of the modules is used to decode the data to produce decoded data (see, for example, step 304 of FIG. 3). The central processing unit 150 may then provide the decoded data (including, but not limited to, raw data) for further analysis (see, for example, step 305 of FIG. 3).

For example, in one embodiment, the decoded data includes image data frames produced by an image sensor (e.g., see frames 160 of FIG. 2). Here, the decoded data may be analyzed to determine to check for dead pixels, pixel sensitivity, and other pixel behavioral characteristics.

According to embodiments described above, protocol-encoded LVDS data produced by a DUT is captured from a data bus on an instrument board of an ATE. The data are captured in encoded form. The protocol-encoded data stream is then transferred to a processing unit separate from the instrument board. At the processing unit, a modular program (or programs) extracts decoded data (including, but not limited to, raw data, from the protocol encoded data stream.

As described above, embodiments of the invention accommodate data that is encoded according to any one of various protocols and provide efficient decoding of encoded data streams. Such protocols may include standard protocols and variations/modifications thereof (e.g., so-called “one-off” protocols that are produced by modifying standard protocols). Accommodation of such data is provided without requiring the performing of hardware/firmware design and verification. In the described embodiments, encoded data are captured generally verbatim and moved to a processing unit which has a set of programmed instructions for extracting raw data from the protocol-encoded data. As such, the extraction is controlled by modifiable software that can be changed efficiently to accommodate different protocols (or variations thereof and/or modifications thereto).

It should be understood that various modifications may be made to the embodiments disclosed herein. Therefore, the above description should not be construed as limiting, but merely as exemplification of the various embodiments. By way of example, other embodiments may be used for decoding LVDS data for purposes other than testing. Those skilled in the art will envision other modifications within the scope and spirit of the claims appended thereto.

What is claimed is:

1. A system for processing a plurality of encoded signals carrying data, the system comprising:
an electronic circuit configured to receive the encoded signals from one or more external devices, wherein the data are encoded in the encoded signals according to one or more of a plurality of protocols; and
a processor configured to receive the encoded signals from the electronic circuit, and to extract the data from the encoded signals by decoding the encoded signals,
wherein the processor is configured to perform decoding according to the plurality of protocols.

2. The system of claim 1, wherein the data comprise low voltage differential signaling (LVDS) data.

3. The system of claim 2, wherein the LVDS data comprise visual image data.

4. The system of claim 2, wherein the one or more of the protocols comprises an LVDS protocol.

5. The system of claim 1, wherein the processor is configured to detect the one or more of the protocols by which the data were encoded in the encoded signals and to decode the encoded signals according to the detected one or more of the protocols.

6. The system of claim 1, wherein the processor is configured to receive information identifying the one or more protocols by which the data were encoded in the encoded signals and to decode the encoded signals according to the identified one or more of the protocols.

7. The system of claim 1, wherein the one or more external devices comprises a device under test (DUT).

8. A method for processing a plurality of encoded signals carrying data, the method comprising:
receiving the encoded signals from one or more external devices, wherein the data are encoded in the encoded signals according to one or more of a plurality of protocols;
sending the encoded signals to a processor for performing decoding according to the plurality of protocols; and
extracting the data from the encoded signals by decoding the encoded signals.

9. The method of claim 8, wherein the data comprise low voltage differential signaling (LVDS) data.

10. The method of claim 9, wherein the LVDS data comprise visual image data.

11. The method of claim 9, wherein the one or more of the protocols comprises an LVDS protocol.

12. The method of claim 8, further comprising detecting at the processor the one or more of the protocols by which the data were encoded in the encoded signals, wherein extracting the data from the encoded signals comprises decoding the encoded signals according to the detected one or more of the protocols.

13. The method of claim 8, further comprising receiving at the processor information identifying the one or more of the protocols by which the data were encoded in the encoded signals, wherein extracting the data from the encoded signals comprises decoding the encoded signals according to the identified one or more of the protocols.

14. The method of claim 8, wherein the one or more external devices comprises a device under test (DUT).
